(19) United States
(12) Patent Application Publication
(10) Pub. No.: US 2015/0048937 A1
(43) Pub. Date: Feb. 19, 2015

(54) SYSTEM AND METHOD FOR ISSUING A NOTICE

(71) Applicant: GM Global Technology Operations LLC, Detroit, MI (US)

(72) Inventors: KEVIN R. HORBATT, MILFORD, MI (US); MICHAEL F. O'LEARY, HOWELL, MI (US)

(73) Assignee: GM Global Technology Operations LLC, Detroit, MI (US)

(21) Appl. No.: 13/968,211

(22) Filed: Aug. 15, 2013

(51) Int. Cl. B60Q 9/00

(52) U.S. Cl. CPC B60Q 9/00
USPC 340/457

(57) ABSTRACT

A method of issuing a notice that a vehicle engine has accidentally been left running starts by determining the engine is running The method then determines if the vehicle has moved more than a set distance in a set time. If the engine remains running for set period of time while the vehicle has not moved more than a set distance, the notice is issued.

### TECHNICAL FIELD

The technical field relates to a system and method of issuing a notice, and more particularly relates to a system and method of issuing a notice that a motor vehicle engine is running

### BACKGROUND

A vehicle operator may unintentionally leave a motor vehicle engine running, which can waste fuel, increase wear and tear on the engine, and can even contribute to an accumulation of exhaust gas if not properly ventilated, such as in some garages. However, on other occasions, a vehicle operator may want a vehicle to remain running, even when the operator is not actively driving the vehicle. For example, if someone leaves a vehicle but wants to control the temperature in the vehicle cabin while away, that person may want the vehicle to remain running so the air conditioner or heater remains operational.

Many vehicle operators have accidentally left the engine of a motor vehicle running for an extended period. The vehicle operators may not have been aware that the engine was running, and only discovered the running engine when returning to the vehicle. Therefore, there is a need for a notification system that will notify the vehicle operator if the vehicle engine has been accidentally left on.

### SUMMARY

In accordance with one embodiment, a wireless communication device has a processor, a receiver, a clock, an output device, and a geographic position indicator. The processor uses the geographic position indicator to determine if the processor moves more than a set distance, and the processor uses the clock to measure a set period of time. If a vehicle signal is received by the receiver over the set period of time while the position of the wireless communication device travels less than the set distance, then a notice is issued with the output device.

In accordance with another embodiment, a vehicle has an engine with a run switch, and the vehicle also has a vehicle transmitter. The vehicle transmitter is configured to transmit the vehicle signal only while the run switch is activated. A wireless communication device has a processor, a receiver for the vehicle signal, an output device for issuing a notice, a geographic position indicator to determine if the wireless communication has moved more than a set distance, and a clock to measure a set period of time. The wireless communication device is configured to issue a notice with the output device if the receiver receives the vehicle signal over the set period of time while the wireless communication device moves less than the set distance.

In accordance with yet another embodiment, the wireless communication device determines it has not moved more than a set distance within a set period of time. The wireless communication device also determines if the vehicle engine has been running during the same period of time. If the wireless communication device has not moved more than set distance while the engine is running, then the wireless communication device issues the notice.

### DESCRIPTION OF THE DRAWINGS

The exemplary embodiments will hereinafter be described in conjunction with the following drawing figures, wherein like numerals denote like elements, and wherein:

FIG. 1 is vehicle schematic diagram showing various components of a vehicle in accordance with one embodiment, wherein dotted lines are used to show wireless communications.

FIG. 2 is a flow chart of one embodiment of the logic used to determine if a notice should be issued, where diamonds represent a yes or no determination with the yes answer exiting the bottom of the diamond and the no answer exiting the side of the diamond.

FIG. 3 is a schematic diagram showing various components of a wireless communication device in accordance with one embodiment, and a vehicle communicating with the wireless communication device.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Vehicle operators may want to know if a vehicle engine has been accidentally left running Automated systems can be used to alert the vehicle operator of a running engine, but automated systems use specific criteria for determining when to take actions. Selected criteria can be established to determine that an engine may have accidentally been left running in a vehicle. In one embodiment, the criteria may be (i) the engine of the vehicle has been running over a set period of time, and (ii) the vehicle has not moved during that set period of time. Systems and methods may then be used to issue a notice to the vehicle operator that the engine is running The vehicle operator is then aware of the situation, and can turn the engine off if desired.

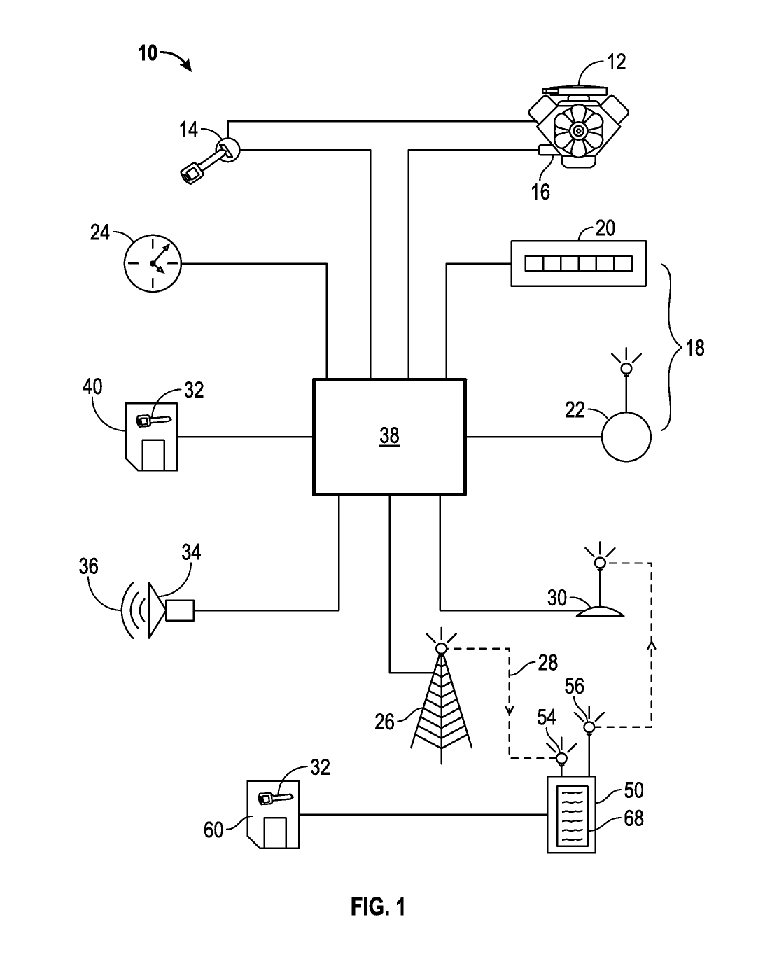

FIG. 1 is a schematic diagram of a vehicle 10 including an engine 12. The engine 12 may be an internal combustion engine, which ignites a mixture of fuel and air within a cylinder to provide a motive force. The vehicle 10 may include a run switch 14, which is a switch that is activated when the engine 12 on. The run switch 14 may also turn on other features and aspects of the vehicle 10, and the various features and aspects may vary from one vehicle 10 to the next. In some embodiments, the run switch 14 turns on the radio, and in other embodiments the run switch 14 activates local power outlets, such as the type used for cigarette lighters. In many vehicles 10, the run switch 14 is activated by turning a key in the ignition, but in other embodiments the run switch 14 may be activated by a key fob. The key fob uses electromagnetic radiation to communicate with the vehicle 10, such as radio waves or the communication standard known by the trademark BLUETOOTH®.

After the run switch 14 is activated, the engine 12 can be started with a separate action, such as turning the key in the ignition to the “start” position or pressing an engine start button in the vehicle 10. The run switch 14 allows the engine 12 to run, but does not require the engine 12 to be running, such as when a vehicle 10 is turned on but before the vehicle engine 12 is started.

The vehicle 10 includes a plurality of sensors for detecting various parameters regarding the vehicle 10. The sensors send a signal indicating the status of one or more vehicle components. One of the plurality of sensors may be an engine running sensor 16, which detects if the engine 12 is running or not. Many different measurements can be used to detect if the engine 12 is running, including but not limited to a revolution per minute (RPM) reading for the engine 12 or a transmission attached thereto, a fuel flow meter that detects fuel flow to the engine 12, an air flow meter that detects air flow to the engine, an exhaust sensor that detects flow or various combustion products, or any other component which indicates the engine 12 is running The status of the engine 12 as either running or not running may be saved in a memory (i.e., a status buffer) for reference by various vehicle components.

The vehicle 10 may also include a motion detector 18, which measures how far the vehicle 10 has travelled. The motion detector 18 may be an odometer 20 which records the distance the vehicle 10 has traveled based on movement within the vehicle 10. For example, the odometer 20 may be connected to the drive shaft or the output of the transmission. The odometer 20 can also be coupled to a wheel, the engine 12, the speedometer, or other components. Alternatively, the motion detector 18 may be a vehicle geographic position indicator 22, such as a global positioning system (GPS) or the terrestrial LOng RAnge Navigation (LORAN) system using low frequency radio signals from fixed beacons. The vehicle geographic position indicator 22 uses wireless transmissions of electromagnetic radiation, such as radio waves or microwaves, to determine position.

The vehicle 10 may include a vehicle clock 24, which may have several different uses. The vehicle clock 24 can be digital or analog, and there may be several different vehicle clocks 24 for different purposes, or one vehicle clock 24 used for several different purposes. The clock 24 may be any processor-based clock, timer, or counter capable of measuring time, and in some embodiments a separate clock 24 is visible in the cabin for the occupant's convenience. The vehicle clock 24 measures time, and the vehicle clock 24 can be configured to measure elapsed time, which begins at a given start point and advances from there.

The vehicle 10 also includes a vehicle transmitter 26, which transmits a wireless vehicle signal 28. The vehicle signal 28 is a form of electromagnetic radiation, such as radio waves within the consumer electronics frequency band. The vehicle 10 may also have a vehicle receiver 30 to receive signals. In some embodiments, the vehicle receiver 30 may use the same antenna as the vehicle transmitter 26. The vehicle transmitter 26 may transmit the vehicle signal 28 using the communication protocol known by the trademark BLUETOOTH®, which uses microwaves ranging from about 2400 millihertz (MHz) to about 2480 millihertz (MHz). Other wireless communication protocols may also be used, such as those described by the standards identified as Wi-Fi by the Institute of Electrical and Electronics Engineers (IEEE).

The vehicle signal 28 may be transmitted with limited power, such as a maximum transmission power of 100 milliwatts, to limit the vehicle signal range. The BLUETOOTH® protocol limits the transmitting power to three different classes: Class 1 with a maximum power of 100 milliwatts; Class 2 with a maximum power of 2.5 milliwatts; and Class 3 with a maximum power of 1 milliwatt. The BLUETOOTH® communications are effective for a limited range, because the strength of the signal is limited. Therefore, BLUETOOTH® communications are only effective over short distances, such as about 100 meters, about 10 meters, or about 1 meter for Classes 1, 2, and 3, respectively. These ranges can vary based on signal strength, intervening objects, interference, and other factors, but the BLUETOOTH® signals are generally not effective for extended distances, such as more than a kilometer. Even if the BLUETOOTH® protocol is not used, the transmission power of the vehicle signal 28 may be limited.

The BLUETOOTH® protocol utilizes short alternating messages between two different devices, such as the vehicle transmitter 26 and a wireless communication device 50. In some embodiments, the communications between two devices may be non-secure, in which case the communication signals are sent and received by any device within range. In other embodiments, the communications between two or more devices may be more secure, such that only specifically allowed devices can properly encrypt and decrypt secure messages. The two devices may be bonded to increase security, and the bond is created through a process called pairing. During the pairing process, the two different devices create a link key 32 which is shared. The link key 32 may be a number saved by each device, where the same link key 32 number is saved by each device. The link key 32 is then used to verify the bond, and different types of link keys 32 may be utilized. An encryption key may be derived from the link key 32, so a device may utilize the link key 32 to properly encrypt or decrypt secure messages from the other device. Link key 32 utilization and BLUETOOTH® security measures are known by those skilled in the art. The vehicle signal 28 may be continuous or intermittent in various embodiments, and different signal protocols may be used.

The vehicle 10 may also have a horn 34 or other notice device that can be used to issue a notice 36 for the vehicle operator. The notice 36 can be as simple as an audible honk of the horn 34, and the honk can be in some set pattern such as two short honks and then a longer honk. Other honk patterns could also be used, and the honks could be combined with a flash of the lights on the vehicle 10, a transmission from a radio or stereo within the vehicle 10, or other forms of notice. As such, the notice 36 may not include an express statement that the engine 12 may have accidentally been left running, but may merely be a signal. The notice 36 could also be a transmission from the vehicle transmitter 26, such as a text, page, e-mail, or telephone call directed to the vehicle operator.

The vehicle 10 also includes a controller 38, which includes any combination of hardware and software configured to determine when the engine 12 may have been accidentally left running, to determine if the vehicle 12 has moved, to determine other details regarding the vehicle 12, and to control selected actions within the vehicle 12. The controller 38 can include any type of processor or multiple processors, integrated circuits such as a microprocessor, or any suitable number of integrated circuit devices and/or circuitry working in cooperation to accomplish the tasks of the controller 38. The controller 38 executes one or more programs that may be stored within a controller memory 40. The controller memory 40 may save various other data as well, such as the link key 32. The controller 38 may include, or have access to, any type of memory, including but not limited to random access memory (RAM), read only memory (ROM), erasable programmable read only memory (EPROM), electrically erasable programmable read only memory (EEPROM), and non-volatile random access memory (NVRAM). The controller memory 40 can store any information needed for the operation of the controller 38, as described herein.

The controller 38 may be coupled to many of the components in the vehicle 10. For example, the controller 38 may be coupled to the engine 12 and/or the engine running sensor 16, the run switch 14, the motion detector 18, the vehicle clock 24, the vehicle transmitter 26, the vehicle receiver 30, the horn 34, the controller memory 40, and many other vehicle components. The coupling of the controller 38 to the other components may be direct or indirect, as long as information can be exchanged. The controller 38 is configured to evaluate the input or signals from the vehicle components and determine if the engine 12 may have been accidentally left running by comparing the signals to predetermined criteria. The controller 38 is also configured to have the notice 36 issued when appropriate.

The controller 38 may be part of other systems on the vehicle 10, or it may be a dedicated device. The controller 38 may be incorporated into the operating systems for a human interaction system such as that associated with the trademark ONSTAR®. The programs and components of an existing human interaction system could be programmed or re-programmed to configure the human interaction system to issue the notice 36 when appropriate. In another embodiment, the controller 38 may be a separate device or system, and the controller 38 may even be installed as a new component in existing vehicles 10. In one embodiment, the controller 38 may be a plug-in device configured to engage the vehicle assembly line diagnostic link (ALDL). In this embodiment, the plug-in device may include a vehicle transmitter 26 and a vehicle receiver 30, or the plug-in controller 38 may utilize an existing vehicle transmitter 26 and vehicle receiver 30. The controller 38 could couple to the various vehicle components using the connections in the ALDL, or other locations with access to the various sensors and vehicle systems.

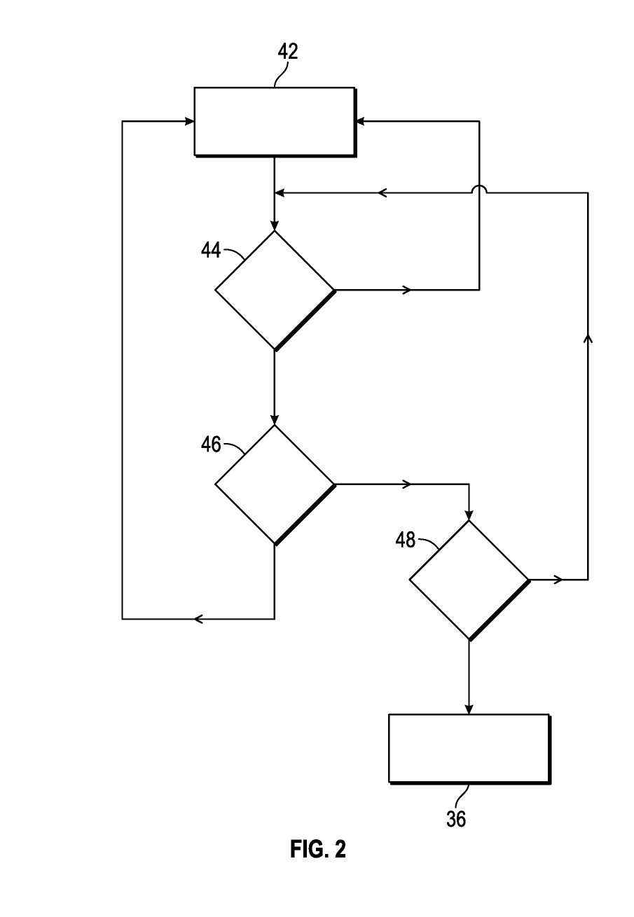

Referring now to FIG. 2, with continuing reference to FIG. 1, one embodiment for the operational logic used to determine if the engine 12 may have been accidentally left running is shown. The diamond shaped boxes represent questions or determinations, which have two possible answers: yes or no. The logic for each answer is indicated by a corner point of the diamond, where the bottom point represents a “yes” answer, and a side point represents a “no” answer. The top box represents the logic start 42. The logic start 42 initiates a timer coupled to the vehicle clock 24. The first question asks “is the engine running” 44. If the engine 12 is not running, the answer is “no,” and the logic returns to the logic start 42 and re-sets the timer. If the engine 12 is running, the answer is “yes” and the logic flows to the next question. The next question asks “has the vehicle moved” 46, which may be defined by the vehicle moving more than a set distance. In one embodiment, the controller 38 utilizes the motion detector 18 to determine if the vehicle has moved. Some motion detectors 18 may indicate small movements or changes in position even when no movement has occurred, so requiring movement of less than a set distance allows for minor inaccurate readings from the motion detector 18 without upsetting the logic. The set distance should be a small distance that is slightly larger than any expected inaccurate readings from the motion detector 18, and may be 1 meter, 10 meters, 100 meters, or a wide variety of distances in various embodiments. If the answer is “yes,” then the logic returns to the logic start 42 and re-sets the timer.

If the answer to the “has the vehicle moved” 46 question is “no,” the logic advances to the next question, which is “has the timer expired” 48. The timer advances from a start point, and the timer expires when a set time has elapsed. If the answer is “no”, the logic returns to the first question, “is the engine running” 44, but does not re-set the timer. Therefore, the timer continues to advance without a re-set, and the elapsed time increases with the next run through the logic. If the answer to “has the timer expired” 48 is yes, then the logic advances to issuing the notice 36. Other embodiments of the logic are also possible. For example, other embodiments of the logic could be established to start the timer when first determining the engine 12 was running, so the logic would be in a hold state while the engine 12 was turned off

Most engines 12 are not left running for extended periods when the vehicle 10 does not move, so the set time is established at some time that exceeds the maximum expected time for an engine 12 to be running without vehicle movement while the vehicle 10 is actively being used. However, the set time should not be set so large that the notice 36 is significantly delayed when the engine 12 is accidentally left running. The set time may be about 1 hour, 2 hours, 3 hours, or a wide variety of time periods in various embodiments. Once the notice 36 has been issued, the logic may return to the logic start 42 and begin anew with a re-set timer in one embodiment, or the logic may advance to a stop condition in other embodiments. The stop condition may advance to the logic start 42 when certain actions occur, such as turning off the engine 12, moving the vehicle 10, or other actions.

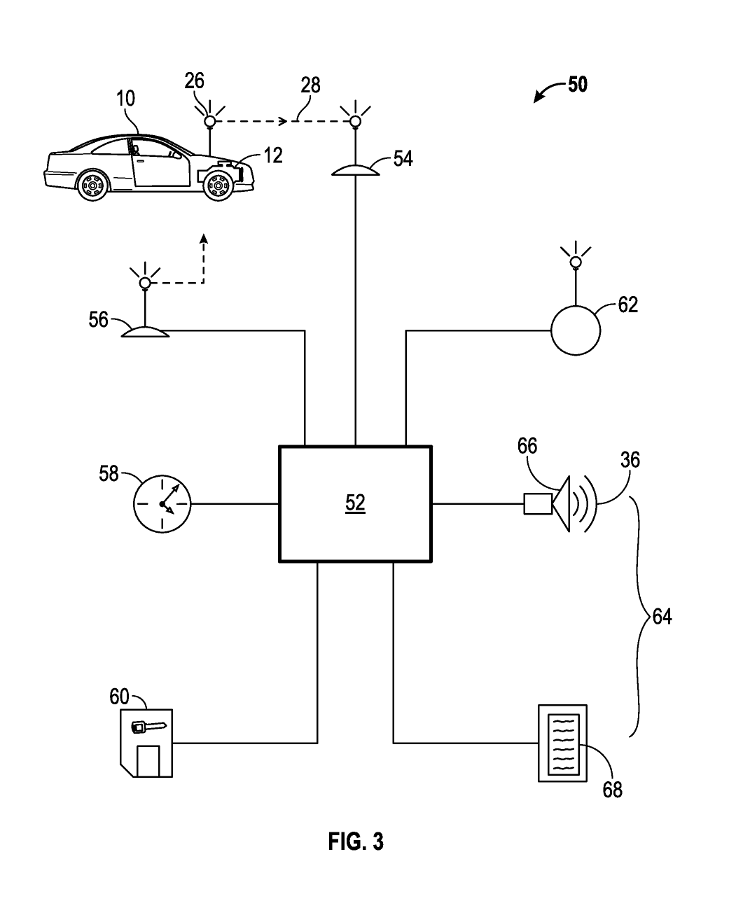

Reference is now made to FIG. 3, with continuing reference to FIGS. 1 and 2. FIG. 3 represents a wireless communication device 50, which may be used in another embodiment. The wireless communication device 50 may be a smart phone, a radio, a tablet computer, a laptop computer, or a wide variety of other devices. The words “communication device” are abbreviated CD below to designate components of the wireless communication device 50. The wireless communication device 50 has a CD processor 52 which is coupled to a CD receiver 54, a CD transmitter 56, a CD clock 58, CD memory 60, a CD geographic position indicator 62, and a CD output device 64. The CD output device 64 may be a CD speaker 66, a CD display 68, a CD vibration device, or other devices for outputting a notice 36.

The wireless communication device 50 may have wires and electrical connections within the wireless communication device 50, but is capable of sending and receiving communications wirelessly. Some wireless communication devices 50 may have plug-ins or other connections such that the device can send and receive communications over a wire, but the devices are also capable of sending and receiving communications without a wire.

The wireless communication device 50 may be positioned relatively close to the vehicle 10, so the wireless communication device 50 is within range of the vehicle signals 28 which are transmitted while the engine 12 is running or while the run switch 14 is activated. The wireless communication device 50 may save the link key 32 in the CD memory 60, and the controller 38 of the vehicle 10 may save the same link key 32 in the controller memory 40, so the vehicle signals 28 and other communications between the vehicle 10 and the wireless communication device 50 are more secure. However, in other embodiments, the communications may not be secure.

This wireless communication device 50 may be configured to utilize the logic shown in FIG. 2. In one embodiment, the wireless communication device 50 interprets the reception of the vehicle signals 28 as a “yes” answer to the logic question “is the engine running” 44. The vehicle signal 28 is transmitted when the engine 12 is running (or when the run switch 14 is activated), and the vehicle signal 28 is not transmitted otherwise. The vehicle signal 28 may have a relatively short range, because it is transmitted with relatively low power, so the wireless communication device 50 would be relatively close to the vehicle 10 while receiving the vehicle signal 28.

The wireless communication device 50 only receives the vehicle signal 28 when (1) the wireless communication device is within range of the vehicle transmitter 26, and (2) the engine 12 is running or the run switch 14 is activated. The run switch 14 is normally deactivated when the engine 12 is not running, so activation of the run switch 14 is a relatively reliable indication that the engine 12 is running. The vehicle signal 28 may be transmitted intermittently over the set period of time, based on the communication protocol utilized. However, during the set period of time, the wireless communication device 50 should receive the vehicle signal 28 either continuously, or regularly and at the expected intervals, such that the vehicle signal 28 indicates the engine 12 is running during the entire set period of time. In other words, the wireless communication device 50 should receive the vehicle signal 28 from the beginning of the set period of time to the end of the set period of time, even though the vehicle signal 28 may be transmitted at expected intervals during this period.

The wireless communication device 50 can answer the logic question “has the vehicle moved” 46 by determining if the wireless communication device 50 has moved more than a set distance. If the vehicle 10 were moving, and the wireless communication device 50 remained in range of the vehicle signal 28, then the wireless communication device 50 would also move. If the vehicle 10 were moving and the wireless communication device 50 was not in the vehicle 10, then the wireless communication device 50 may lose the relatively low strength vehicle signal 28, so no notice 36 would be issued. The wireless communication device 50 utilizes the CD geographic position indicator 62 to determine motion of the wireless communication device 50.

If the engine 12 is switched off, no vehicle signal 28 is transmitted, and no notice 36 is issued. If the engine 12 is running, there are few possible scenarios. (1) The vehicle 10 moves with the wireless communication device 50, so the wireless communication device 50 will move more than the set distance and no notice 36 is issued. This would apply if the wireless communication device 50 were within the vehicle 10, or were travelling with the vehicle 10, such as in a convoy. (2) The vehicle 10 moves, but the wireless communication device 50 is left behind, in which case the wireless communication device 50 no longer receives the vehicle signal 28 once the vehicle 10 moves out of transmission range, so no notice 36 is issued. (3) The vehicle 10 remains stationary, and the wireless communication device 50 also remains stationary, so the vehicle signal 28 is received and the notice 36 is issued.

The system is not infallible, but provides accurate notices most of the time. For example, if the engine 12 is left running with the vehicle 10 in a driveway, and the wireless communication 50 moves out of range so the vehicle signal 28 is lost, no notice 36 would be issued even though the engine 12 was accidentally left running Also, if the vehicle 10 were moving within a small geographic area, such as back and forth in a driveway, the wireless communication device 50 may receive the vehicle signal 28 while not moving more than the set distance, so a notice 36 would be issued even though the vehicle 10 was moving within a small area. The wireless communication device 50 is configured to determine (1) if the engine 12 is running, and (2) if the wireless communication device 50 has moved more than a set distance, and these determinations are good (but not perfect) for determining that an engine 12 has accidentally been left running However, a wireless communication device 50 that usually provides accurate notices 36 is still worthwhile, and implementation is quick, easy, and inexpensive.

The set distance for the wireless communication device 50 may be somewhat larger than for the controller 38 in the vehicle 10, because the wireless communication device 50 may move somewhat and yet stay in range of a stationary vehicle 10. For example, a vehicle operator might park her vehicle 10 at her home, accidentally leave the engine 12 running, and then move about her house and yard with her wireless communication device 50. The set distance for the wireless communication device 50 may be 1 meter, 10 meters, 100 meters, or many other distances. If a second person drove the vehicle 10, the wireless communication device 50 would lose the vehicle signal 28 when the distance between the vehicle 10 and the wireless communication device 50 exceeded the vehicle signal range. A notice 36 is not issued when the wireless communication device 50 does not receive the vehicle signal 28, so no notice 36 would be issued.

The communication device 50 has a CD clock 58 which can be used with a timer to answer the logic question “has the timer expired” 48. The wireless communication device 50 can initiate the logic process (and the timer) with the logic start 42 when the vehicle signal 28 is received after a period of not receiving the vehicle signal 28. Other actions may also be used to initiate the logic process and the timer.

The wireless communication device 50 can be used to evaluate information and determine if a notice is needed, as described above. The wireless communication device 50 can also issue a notice 28, because the wireless communication device 50 has a CD output device 64. The notice 36 could be text message, a phone call, an e-mail, a phone ring, or some other means of notifying the vehicle operator that the engine 12 was running In some embodiments, the notice 36 begins with an audible signal issued by the CD speaker 66, such as the ring tone for a telephone call or incoming text message. The notice 36 could also include a transmission from the CD transmitter 56 instructing the vehicle 10 to issue some form of notice 36, such as a honk of the horn 34 and/or a flash of the lights.

A simple program or “app” can be downloaded onto the CD processor 52 and/or CD memory 60 which allows a vehicle operator to receive notices 36 when the engine 12 has been accidentally left running The program or “app” may be available for vehicles equipped with wireless communication systems, such as BLUETOOTH® or other systems, which transmit vehicle signals 28 when the engine 12 is running (or the run switch 14 is activated), and which do not transmit vehicle signals 28 when the engine 12 is not running (or the run switch 14 is not activated). The wireless communication device 50 should have the proper components to (a) communication wirelessly with the vehicle 10, (b) determine if the wireless communication device 50 has moved more than a set distance, (c) and set and operate a timer. These components are available on many existing devices.

In a non-limiting exemplary embodiment, the wireless communication device 50 is a smart phone. The wireless communication device 50 begins to receive a vehicle signal 28 at time zero, starts the timer using the CD clock 58, and begins the logic routine. The vehicle signal 28 is received from the start to the end of the set time of 2 hours, and the position of the wireless communication device 50 does not change by more than the set distance of 100 meters. The wireless communication device 50 then issues a notice 36 by ringing the smart phone and sending a text message saying “the vehicle engine is running.”

In some embodiments, the wireless communication device 50 or the vehicle controller 38 has a cancel option, where the vehicle operator can deactivate the notice system. Some vehicle operators may not like the system, or the vehicle operator may decide they want the system inactive for some activity or period of time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of issuing a notice, the method comprising the steps of:
determining a wireless communication device has not moved more than a set distance within a set period of time;
determining an engine of a vehicle has been running during the set period of time; and
issuing a notice from the wireless communication device if the wireless communication device has not moved more than the set distance, and engine has been running, during the set period of time.

2. The method of claim 1 wherein determining the engine of the vehicle has been running further comprises determining if a vehicle signal has been received by the wireless communication device during the set period of time.

3. The method of claim 2 wherein determining the engine of the vehicle has been running further comprises determining the engine of the vehicle has been running, wherein the vehicle is configured to transmit the vehicle signal only while the engine is running

4. The method of claim 2 wherein determining the engine of the vehicle has been running further comprises determining the engine of the vehicle has been running, wherein the vehicle is configured to transmit the vehicle signal only while an engine switch is turned on.

5. The method of claim 2 wherein determining the vehicle signal has been received further comprises determining if the vehicle signal has been received from the beginning to the end of the set period of time.

6. The method of claim 1 further comprising pairing the wireless communication device with the vehicle.

7. The method of claim 1 further comprising pairing the wireless communication device with the vehicle such that a link key is saved in a communication device memory.

8. The method of claim 1 wherein issuing the notice further comprises activating a communication device speaker.

9. The method of claim 1 wherein issuing the notice further comprises transmitting instructions from the wireless communication device to activate a vehicle horn.

10. A system for issuing a notice comprising:
a wireless communication device, wherein the wireless communication device further comprises;
a geographic position indicator;
a clock;
a receiver;
an output device; and
a processor coupled to the geographic position indicator, the clock, the receiver, and the output device, wherein the receiver is configured to receive a vehicle signal, wherein the processor is configured to measure a set period of time with the clock, and wherein the processor is further configured to issue the notice with the output device when the vehicle signal is received during the set period of time while the geographic position indicator indicates a location of the processor has not changed by more than a set distance.

11. The system of claim 10 further comprising a speaker coupled to the processor, wherein the notice comprises an audible signal issued by the speaker.

12. The system of claim 10 wherein the wireless communication device further comprises memory, a link key is saved in the memory, and wherein the processor is configured to utilize the link key to decrypt the vehicle signal.

13. The system of claim 10 wherein the wireless communication device is configured to receive the vehicle signal from a frequency of about 2400 millihertz to about 2480 millihertz.

14. The system of claim 10 further comprising a vehicle, wherein the vehicle comprises a vehicle transmitter and an engine, and wherein the vehicle transmitter issues the vehicle signal only while the engine is running.

15. The system of claim 10 further comprising a vehicle, wherein the vehicle comprises a vehicle transmitter and an engine switch, and wherein the vehicle transmitter issues the vehicle signal only while the engine switch is activated.

16. The system of claim 10 wherein the set time is about 2 hours.

17. The system of claim 10 wherein the processor is configured to issue the notice if the vehicle signal is received from the beginning to the end of the set period of time.

18. A system for issuing a notice comprising:
a vehicle having an engine, a run switch for the engine, and a vehicle transmitter, wherein the vehicle transmitter is configured to transmit a vehicle signal only while the run switch is activated; and
a wireless communication device comprising a geographic position indicator, a clock, a receiver, an output device, and a processor, wherein the processor is configured to determine if the wireless communication device has moved more than a set distance using the geographic position indicator, the processor is configured to measure a set period of time with the clock, and the processor is configured to issue the notice with the output device if the vehicle signal is received during the set period of time while the position of the wireless communication device changes by less than the set distance.

19. The system of claim 18 wherein the wireless communication device further comprises a communication device memory, the vehicle further comprises a controller memory, wherein the same link key is saved in the communication device memory and the controller memory, and wherein the link key is used to decrypt signals.

20. The system of claim 18 wherein the vehicle transmitter is further configured to transmit the vehicle signal only while the engine is running.
